(19) United States
(12) Patent Application Publication
(10) Pub. No.: US 2012/0312119 A1
(43) Pub. Date: Dec. 13, 2012

(54) PEDAL

(76) Inventor: Yu Chul Kim, Siheung-si (KR)

(21) Appl. No.: 13/488,186

(22) Filed: Jun. 4, 2012

(30) Foreign Application Priority Data
Jun. 10, 2011 (KR) 10-2011-0056454

(51) Int. Cl. B62M 3/08

(52) U.S. Cl. 74/594.4

(57) ABSTRACT

A pedal for use in pedal exercise equipment includes a connection shaft connected to a crank rod; a pedal body rotatively connected to the connection shaft, inclination control plates, which have hinge pin connection holes at both side end portions and are respectively inserted to the inside of an inner upper front portion, an inner upper rear portion, an inner lower front portion and an inner lower rear portion of the pedal body; hinge pins, which are provided with control bolt coupling holes in the center of outer peripheries thereof in the vertical direction, and inserted to the inside of the hinge pin connection holes of the respective inclination control plates in the to and fro direction. Control bolts are provided to control left vertical protrusion amounts and right vertical protrusion amounts of the inclination control plates.

### BACKGROUND OF THE INVENTION

1. Field of the Invention

The present invention relates to a pedal used in various pedal exercise equipment such as bicycles, and more particularly to, a pedal, in which the stepping angle of a sole on a pedal body may be controlled in a predetermined range in the right and left directions, so that it is possible to realize stable pedal stepping on the pedal body.

2. Description of the Related Art

Recently, there have been suggested various kinds of pedal exercise equipment to which the present invention relates. There are, for example, bicycles for traveling roads by rotating wheels using pedals, bicycle type exercise equipment for carrying out leg exercise on the spot, or the like.

FIG. 1 shows a perspective view of a prior art pedal in an assembled state and FIG. 2 shows a perspective view of the same prior art pedal.

In a pedal exercise equipment as shown in FIG. 1, a pedal 100′ is connected to a driving sprocket 300′ via a crank rod 200′ and the driving sprocket 300′ is connected to a driven sprocket, which is connected to wheels via chains.

The pedal 100′, as shown in FIG. 2, includes a connection shaft 110′ which is connected to the crank rod 200′; and a rectangular pedal body 120′ mounted to the connection shaft 110′ for freely rotating and contacting a sole, wherein the body 120′ is kept horizontally with respect to the ground surface when the connection shaft 110′ is connected to the crank rod 200′.

Therefore, the stepping angle of the sole of a user, which contacts the top surface of the pedal body 120′, becomes 0°, so that the sole of the user may be slipped in the right or left direction of the pedal body 120′ according to the shape of the sole of the user when the crank rod is rotated by pressing the pedal body 120′. Particularly, if the degree of slippage in the direction opposite the crank rod connection side is severe, the sole of the user may deviate from the pedal body 120′.

In addition, the pedal 100′ promotes effective pedal exercise wherein a large driving force may be obtained from a small force because a moment value becomes increased as the foot effort is more concentrated on the opposite side of the crank rod connection side in the stepping portion of the pedal body 120′.

However, in the prior art pedal 100′ as shown in FIG. 1 and FIG. 2, the pedal body 120′ is formed as a single part and all the top surface and the bottom surface of the pedal body 120′ are formed horizontally. Therefore, it is difficult to concentrate the foot effort to the opposite side of the crank rod connection side. In addition, if the foot effort is concentrated on the opposite side of the crank rod connection side of the pedal body 120′, the sole is more likely to slip to the outside of the pedal body 120′, deviating from the pedal body 120′.

Therefore, in order to make the foot effort to be concentrated on the opposite side of the crank rod connection side of the pedal body 120′ while stably securing the sole to the pedal body 120′, it is preferable to form the pedal body 120′ with an inclination such that the top surface and the bottom surface are high at the opposite side of the crank rod connection side and low at the crank rod connection side, making the stepping angle of the sole larger than 0°.

Meanwhile, statistically 87% of human feet have varus phenomena, 9% have valgus phenomena in the state that a load is not applied thereto and only 4% are in parallel to the surface of ground at foreparts thereof.

Of course, the above phenomena are normal characteristics of humans and serve as suspension to absorb impacts from the ground at the time of walking.

However, in the case of pedaling the entire forepart of a foot comes in contact with a pedal. Therefore, joint portions which are vertically maintained at the time of walking are bent inwards or outwards according to the twisted degree of a sole. This deformation of joint portions causes pain or damage and results in the loss of vertical force.

In order to find out the phenomenon that a user's feet have, it would be better for the user to straightly stand up in front of a mirror and lift one of his legs.

If the shape of his foot reflected on the mirror is close to any one of the two views, that is the natural shape of his foot.

FIG. 3 is a view showing a varus foot facing to the outside, and FIG. 4 is a view showing a valgus foot facing to the inside. FIG. 5 is a view showing a case, in which a foot is biased to the outside as the foot faces to the outside due to the varus phenomenon during pedaling.

FIG. 6 is a view showing a foot, wherein force is ideally distributed over the foot during pedaling.

In the case of the varus foot as shown in FIG. 5, concentrated force between a pedal and a foot is biased outwards, decreasing pedaling efficiencies. If force is ideally distributed as shown in FIG. 6, the force applied to the foot is maximized and stable pedaling may be expected.

In addition, in the case of the varus or valgus foot, a knee may come inwards or go outwards at the time of pedaling.

The problems of cyclists who complain pain at the outside or inside portion of knees are mostly resulted from the varus and valgus phenomena. Even though there is no pain revealed, if force is not vertically applied during pedaling, the force is likely to be lost, decreasing the pedaling efficiencies.

FIG. 7 is a view showing a leg, wherein a knee comes inwards by the varus foot which faces to the outside during pedaling, and FIG. 8 is a view showing a leg during ideal pedaling.

As described above, in order to carry out ideal pedaling according to the varus and valgus phenomena, it is necessary to control a pedal stepping angle in the right and left direction according to the body type of a user. However, it is not possible to the pedal stepping angle in the prior art pedal including the pedal as shown in FIG. 1 and FIG. 2. Further, in order to set an ideal pedal stepping angle in the right and left direction in the prior art pedal, it is necessary to complicatedly mount an additionally prepared wedge to the front and rear surfaces of a pedal body.

### SUMMARY OF THE INVENTION

### Problems that the Invention is to Solve

Therefore, the present invention is derived to resolve the above and any other problems and disadvantages of the prior art pedal, and has an object to provide a pedal,

in which pedal stepping angle in the right and left direction may be controlled according to the body type of a user so as to realize ideal pedaling, and the concern about pain and damage is reduced while largely improving pedaling efficiencies.

### Means for Solving the Problem

In order to accomplish the above objects, there is provided a pedal, which includes: a connection shaft connected to a crank rod of a pedal exercise equipment; a pedal body rotatively connected to the connection shaft; inclination control plates, which have hinge pin connection holes at both side end portions and are respectively inserted to the inside of an inner upper front portion, an inner upper rear portion, an inner lower front portion and an inner lower rear portion of the pedal body; hinge pins, which are provided with control bolt coupling holes in the center of outer peripheries thereof in the vertical direction, and inserted to the inside of the hinge pin connection holes of the respective inclination control plates in the to and fro direction; and control bolts, which are provided with male screw portions at upper and lower portions thereof such that the male screw portions are connected to the hinge pins, and respectively mounted at an inner left front portion, an inner left rear portion, an inner right front portion and an inner right rear portion of the pedal body such that the control bolts control left vertical protrusion amounts and right vertical protrusion amounts of the inclination control plates.

According to pedal of the present invention, the pedal body is provided with a connection shaft insertion hole in the center at one side in the right and left direction such that the connection shafts are inserted to the inside of the connection shaft insertion hole, inclination control plate insertion spaces at an inner upper front portion, an inner upper rear portion, an inner lower front portion and an inner lower rear portion such that the inclination control plates are respectively inserted to the inside of the inclination control plate insertion spaces, and control bolt connection grooves respectively at an inner left front portion, an inner left rear portion, an inner right front portion and an inner right rear portion.

According to pedal of the present invention, the inclination control plates are formed such that plate members are folded in the shape of a U or an inversed U, and have a plurality of ground protrusions provided at an upper end front portion and an upper end rear portion, or a lower end front portion and a lower end rear portion.

In addition, the control bolts are provided with the male screw portions respectively at upper and lower portions of support rings, which are inserted in the control bolt connection grooves of the pedal body, and wrench grooves respectively at upper and lower ends thereof, and the spiral direction of the upper male screw portions and the spiral direction of the lower male screw portions are different from each other.

### Effects of the Invention

According to the pedal of the present invention, it is possible to freely control the stepping angle of a sole in a predetermined range by protruding each inclination control plate with respect to the upper end and the lower end of the pedal body by means of the control bolts. In addition, it is possible to set all the inclination directions such that the pedal body may be downwardly inclined from the left side to the right side and the pedal body may be downwardly inclined from the right side to the left side. Therefore, all the users who have the varus or valgus phenomenon may set an ideal pedal stepping angle according to his body type. Accordingly, force is ideally distributed on his feet at the time of pedaling, such that the force applied to his feet may be maximized and stable pedaling may be expected, noticeably reducing a fatigue degree and the concern of pain or damage.

### BRIEF DESCRIPTION OF THE DRAWINGS

The objects, features and advantages of the present invention will be more clearly understood from the preferred embodiments in the following detailed description in conjunction with the accompanying drawings, in which:

FIG. 1 is a perspective view of a prior art pedal, wherein the pedal is in the mounted state.

FIG. 2 is a perspective view of the same pedal.

FIG. 3 is a view showing a varus foot facing to the outside.

FIG. 4 is a view showing a valgus foot facing to the inside.

FIG. 5 is a view showing a case, in which a foot is biased to the outside as the foot faces to the outside during pedaling.

FIG. 6 is a view showing a foot, wherein a force is ideally distributed over the foot during pedaling.

FIG. 7 is a view showing a leg, wherein a knee comes inwards by the foot facing to the outside during pedaling.

FIG. 8 is a view showing a leg during ideal pedaling.

FIG. 9 is a perspective view showing a pedal according to an embodiment of the present invention.

FIG. 10 is a disassembled perspective view of the pedal according to the same embodiment.

FIG. 11 is a plane view of the same embodiment.

FIG. 12 is a cross-sectional view of the pedal, which is taken along line A-A of FIG. 11.

FIG. 13 is a perspective view of principal parts of the same embodiment.

FIG. 14a is a front view of the principal parts of the same embodiment.

FIG. 14b is a front view of the principal parts of the same embodiment, wherein the pedal is controlled by a user having a foot facing to the outside, and

FIG. 14c is a front view of the principal parts of the same embodiment, wherein the pedal is controlled by a user having a foot facing to the inside.

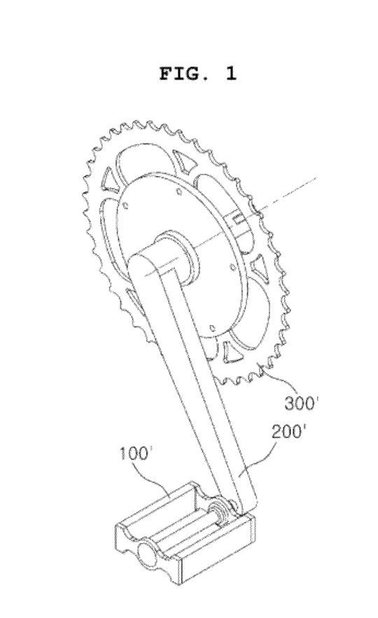

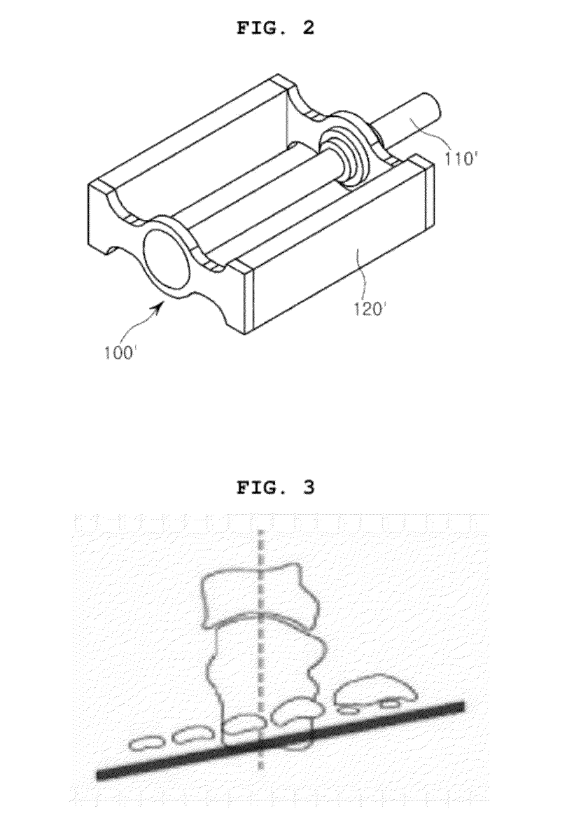

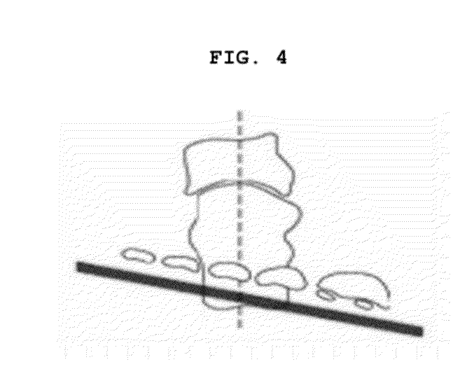

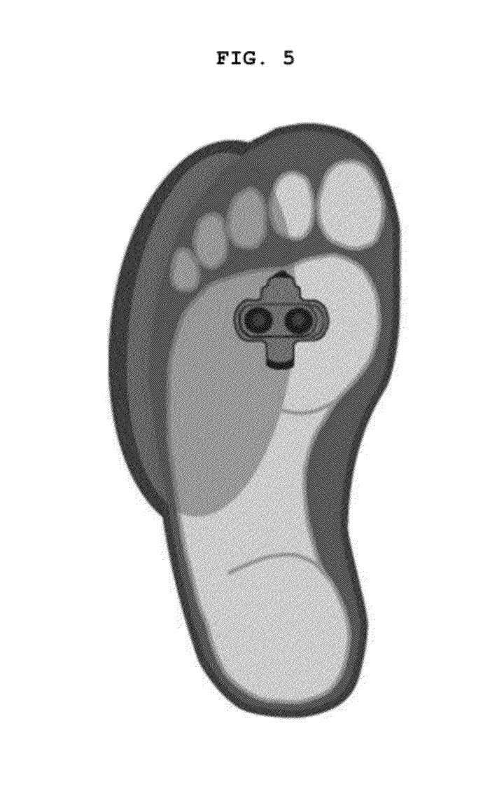

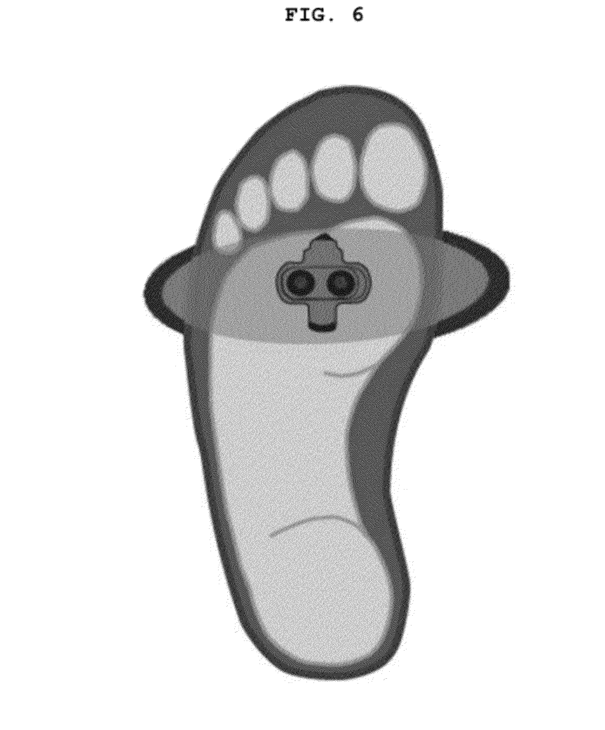

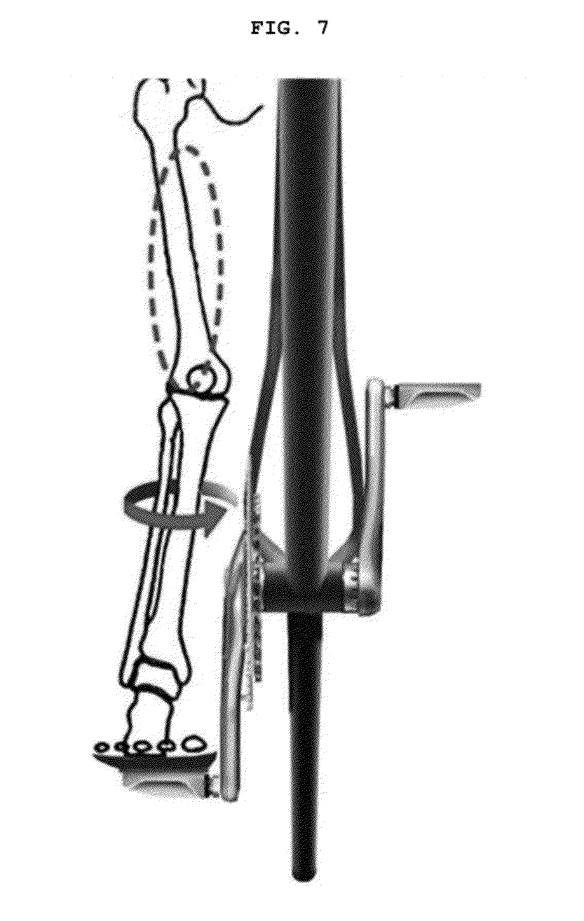

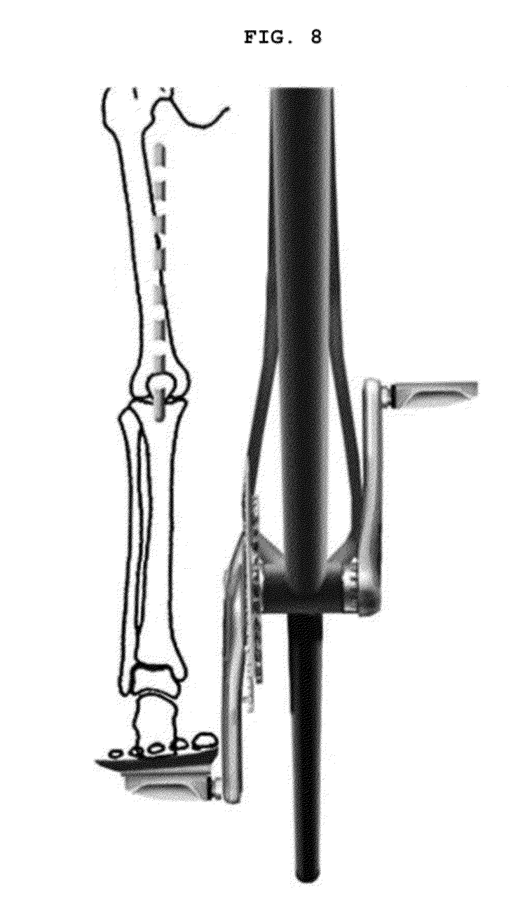

### DETAILED DESCRIPTION OF THE PREFERRED EMBODIMENT

Now, the detailed technical idea of the present invention in order to accomplish the above objects will be described in more detail with reference to the accompanying drawings.

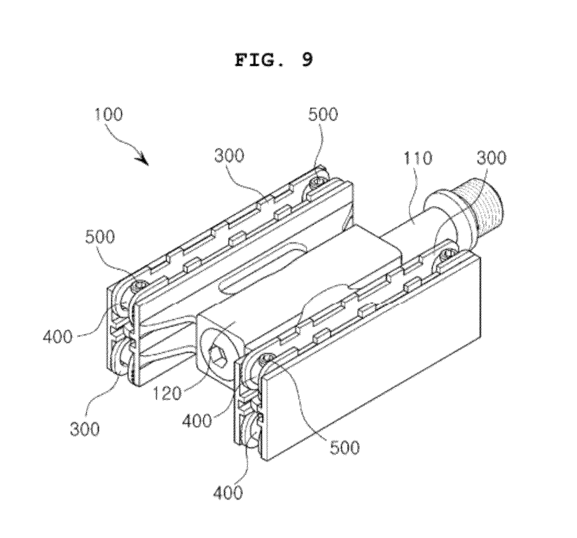

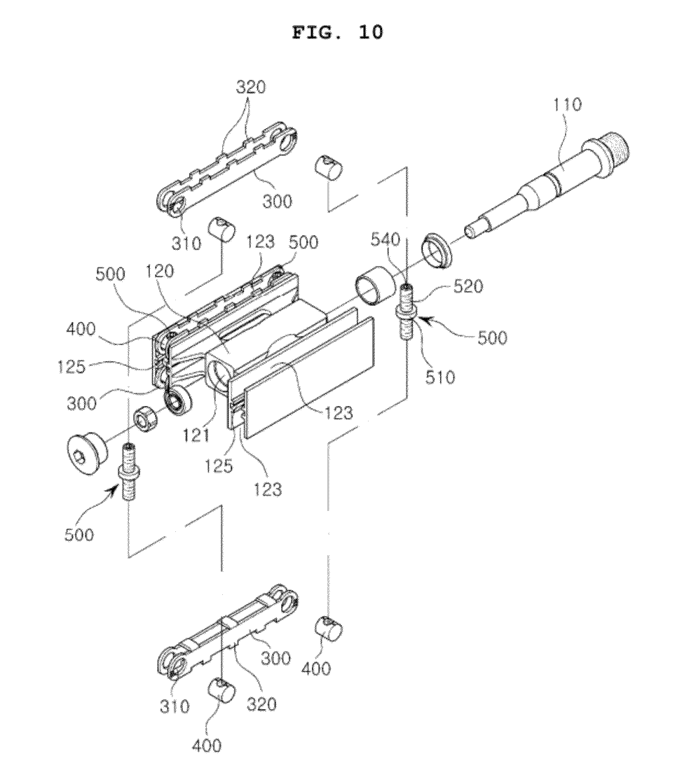

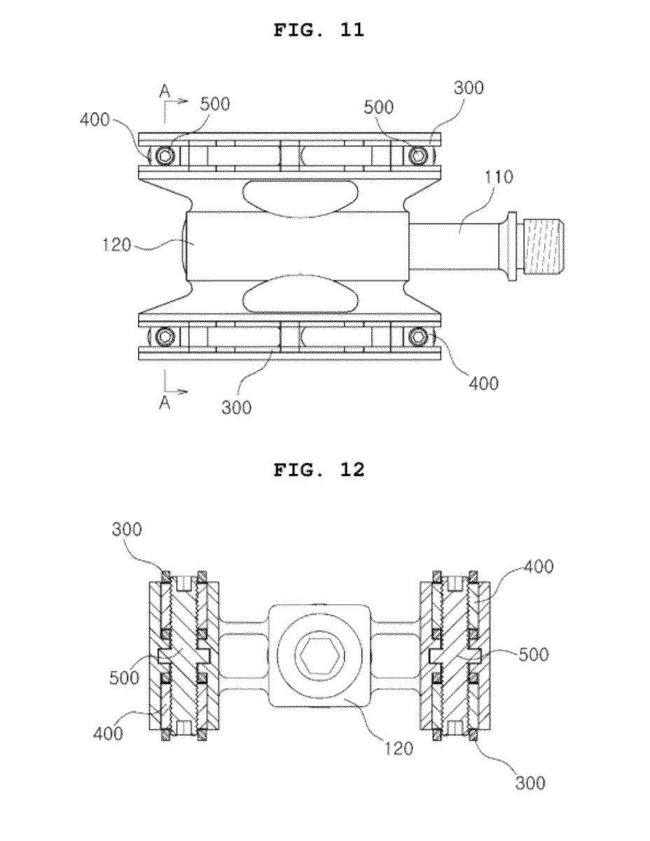

FIG. 9 is a perspective view showing a pedal according to an embodiment of the present invention, FIG. 10 is a disassembled perspective view of the same embodiment, FIG. 11 is a plane view of the same embodiment, and FIG. 12 is a cross-sectional view taken along line A-A of FIG. 11.

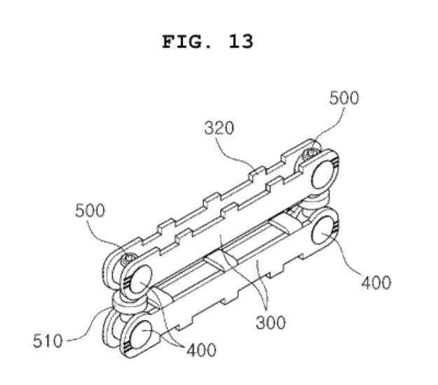

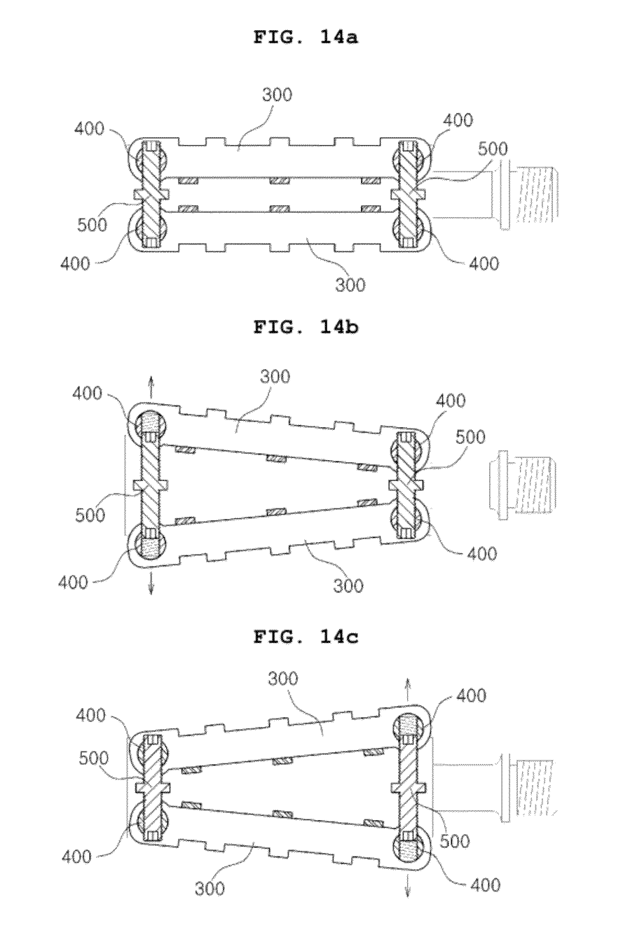

And, FIG. 13 is a perspective view of principal parts of the same embodiment, FIG. 14a to FIG. 14b show front views of the principal parts of the same embodiment, wherein the pedal is in operation.

Referring to FIG. 9 to FIG. 12, a pedal 100 according to the present invention includes: a connection shaft 110 connected to a crank rod of a pedal exercise equipment; a pedal body 120 rotatively connected to the connection shaft 110; inclination control plates 300, which have hinge pin connection holes 310 at both side end portions and are respectively inserted to the inside of an inner upper front portion, an inner upper rear portion, an inner lower front portion and an inner lower rear portion of the pedal body 120; hinge pins 400, which are provided with control bolt coupling holes 410 in the center of outer peripheries thereof in the vertical direction, and inserted to the inside of the hinge pin connection holes 310 of the respective inclination control plates 300 in the to and fro direction; and control bolts 500, which are provided with male screw portions 520, 530 at upper and lower portions thereof such that the male screw portions 520, 530 are connected to the hinge pins 400, and respectively mounted at an inner left front portion, an inner left rear portion, an inner right front portion and an inner right rear portion of the pedal body 120 such that the control bolts 500 control left vertical protrusion amounts and right vertical protrusion amounts of the inclination control plates 300.

In the embodiment as shown in FIG. 9 to FIG. 12, the pedal body 120 is provided with a connection shaft insertion hole 121 in the center at one side in the right and left direction such that the connection shafts 110 are inserted to the inside of the connection shaft insertion hole 121, inclination control plate insertion spaces 123 at an inner upper front portion, an inner upper rear portion, an inner lower front portion and an inner lower rear portion such that the inclination control plates 300 are respectively inserted to the inside of the inclination control plate insertion spaces 123, and control bolt connection grooves 125 respectively at an inner left front portion, an inner left rear portion, an inner right front portion and an inner right rear portion.

The inclination control plates 300 are formed such that plate members are punched and folded in the shape of a U or an inversed U, and have a plurality of ground protrusions 320 at an upper end front portion and an upper end rear portion, or a lower end front portion and a lower end rear portion.

The control bolts 500 are provided with the male screw portions 520, 530 respectively at upper and lower portions of support rings 510, which are inserted in the control bolt connection grooves 125 of the pedal body 120, and wrench grooves 540 respectively at upper and lower ends thereof, wherein the spiral direction of the upper male screw portions 520 and the spiral direction of the lower male screw portions 530 are different from each other.

In the pedal 100 of the present invention as structured above, as the control bolt 500 is rotated in the clockwise direction by means of a working tool such as a wrench, the control bolt 500, which is inserted with the support ring 510 in the fitting groove 125 of the pedal body 120, rotates in the clockwise direction in position. Therefore, the hinge pin 400 at one side, for example, the left side hinge pin 400 which is coupled with an upper screw shaft 520 of the control bolt 500, becomes lifted. Simultaneously, the hinge pin 400 at one side, for example, the left side hinge pin 400 which is coupled with an upper screw shaft 530 of the control bolt 500, becomes lowered. Therefore, the inclination control plate 300 which is mounted at the upper side of the pedal body 120 rotates with respect to the other side hinge pin, for example, the right hinge pin 400 and protruded to the outside of the upper end of the pedal body 120 such that the inclination control plate 300 is inclined in a predetermined angle. Simultaneously, the inclination control plate 300 which is mounted at the lower side of the pedal body 120 rotates with respect to the other side hinge pin, for example, the right hinge pin 400 and protruded to the outside of the lower end of the pedal body 120 such that the inclination control plate 300 is inclined in a predetermined angle.

At this time, the lifting protrusion height of the upper inclination control plate 300 and the lowering protrusion height of the lower inclination control plate 300 are in proportion to the rotation amount of the control bolt 500. Therefore, as the rotation amount of the control bolt 500 increases, each of the inclination control plates 300 becomes more protruded such that the inclination angle, that is, the stepping angle of a sole becomes increased.

Meanwhile, as the control bolt 500 is rotated in the counterclockwise direction, the control bolt 500 rotates in the counterclockwise direction in position. Therefore, the upper hinge pin 400 at one side, which is coupled with the lower screw shaft 530 of the control bolt 500, becomes lowered. Simultaneously, the lower hinge pin 400 at one side which is coupled with a lower screw shaft 530 of the control bolt 500, becomes lifted. Therefore, the inclination control plate 300 which is mounted at the upper side of the pedal body 120 and the inclination control plate 300 which is mounted at the lower side of the pedal body 120 rotate with respect to the upper hinge pin 400 at the other side and the lower hinge pin 400 at the other side. Accordingly, the inclination control plates 300 are received in the pedal body 120 such that the protrusion height becomes decreased and the inclination angle becomes decreased.

As described above, in the pedal 100 of the present invention, corresponding one of the inclination control plates 300 may be protruded to the outside of the pedal body 120 or received in the pedal body 120 according to the rotation direction of the control bolt 500. In addition, the inclination angle of the inclination control plate 300 may be controlled by controlling the degree of protrusion or receiving of the corresponding inclination control plates 300 according to the rotation amount of the control bolt 500.

A user may control the stepping angle of his sole, that is, the inclination angle of the inclination control plate 300 in accordance with his own body type by controlling the front control bolt 500 and the rear control bolt 500 at the crank rod side or the front control bolt 500 and the rear control bolt 500 at the opposite side of the crank rod.

That is, in the case that a varus user whose feet are applied with outward concentrated force between the feet and pedals use the pedal of the present invention, the upper inclination control plate 300 and the lower inclination control plate 300 at the opposite side of a crank rod are protruded to the outside of the pedal body 120 via the front control bolt 500 and the rear control bolt 500 at the opposite side of the crank rod as shown in FIG. 14b, and then the concentrated force between the pedal and the foot may be prevented from being biased outwards. In the case that a valgus user whose feet are applied with inward concentrated force between the feet and pedals use the pedal of the present invention, the upper inclination control plate 300 and the lower inclination control plate 300 at the side of a crank rod are protruded to the outside of the pedal body 120 via the front control bolt 500 and the rear control bolt 500 at the side of the crank rod as shown in FIG. 14c, and then the concentrated force between the pedal and the foot may be prevented from being biased inwards.

Although the present invention has been described in detail by reference to the forgoing embodiments and accompanying drawings, the present invention is not limited thereto and it is apparent to those skilled in the art that various changes and modifications of the present invention maybe made without departing the spirit and scope of the invention.

Description of Reference Numerals and Signs

110: connection shaft

120: pedal body

300: inclination control plate

310: hinge pin connection hole

400: hinge pin

410: control bolt coupling hole

500: control bolt

510: support ring

520, 530: male screw portion

540: wrench groove

What is claimed is:

1. A pedal, comprising:
a connection shaft connected to a crank rod of pedal exercise equipment;
a pedal body rotatively connected to the connection shaft;
inclination control plates, which have hinge pin connection holes at both side end portions and are respectively inserted to the inside of an inner upper front portion, an inner upper rear portion, an inner lower front portion and an inner lower rear portion of the pedal body;
hinge pins, which are provided with control bolt coupling holes in the center of outer peripheries thereof in the vertical direction, and inserted to the inside of the hinge pin connection holes of the respective inclination control plates in the to and fro direction; and
control bolts, which are provided with male screw portions at upper and lower portions thereof such that the male screw portions are connected to the hinge pins, and respectively mounted at an inner left front portion, an inner left rear portion, an inner right front portion and an inner right rear portion of the pedal body such that the control bolts control left vertical protrusion amounts and right vertical protrusion amounts of the inclination control plates.

2. The pedal according to claim 1, wherein the pedal body is provided with a connection shaft insertion hole in the center at one side in the right and left direction such that the connection shafts are inserted to the inside of the connection shaft insertion hole, inclination control plate insertion spaces at an inner upper front portion, an inner upper rear portion, an inner lower front portion and an inner lower rear portion such that the inclination control plates are respectively inserted to the inside of the inclination control plate insertion spaces, and control bolt connection grooves respectively at an inner left front portion, an inner left rear portion, an inner right front portion and an inner right rear portion.

3. The pedal according to claim 1, wherein the inclination control plates 300 are formed such that plate members are punched and folded in the shape of a U or an inversed U, and have a plurality of ground protrusions at an upper end front portion and an upper end rear portion, or a lower end front portion and a lower end rear portion.

4. The pedal according to claim 1, wherein the control bolts are provided with the male screw portions respectively at upper and lower portions of support rings, which are inserted in the control bolt connection grooves of the pedal body, and wrench grooves respectively at upper and lower ends thereof, and the spiral direction of the upper male screw portions and the spiral direction of the lower male screw portions are different from each other.

5. The pedal according to claim 2, wherein the inclination control plates 300 are formed such that plate members are punched and folded in the shape of a U or an inversed U, and have a plurality of ground protrusions at an upper end front portion and an upper end rear portion, or a lower end front portion and a lower end rear portion.

6. The pedal according to claim 2, wherein the control bolts are provided with the male screw portions respectively at upper and lower portions of support rings, which are inserted in the control bolt connection grooves of the pedal body, and wrench grooves respectively at upper and lower ends thereof, and the spiral direction of the upper male screw portions and the spiral direction of the lower male screw portions are different from each other.
